(19) United States
(12) Patent Application Publication
(10) Pub. No.: US 2009/0017282 A1
(43) Pub. Date: Jan. 15, 2009

(54) Method for Opening the Film Layer of Plastic Foam Strip

(75) Inventors: Shahmir Fatherazi, Goettingen (DE); Karl Pflanz, Gleichen (DE); Rebecca Petersen, Flieden (DE)

Correspondence Address: CASELLA & HESPOS, 274 MADISON AVENUE, NEW YORK, NY, 10016, US

(73) Assignee: Sartorius Stedim Biotech GmbH, Gottingen (DE)

(21) Appl. No.: 11/886,682

(22) PCT Filed: Apr. 4, 2006
(86) PCT No.: PCT/EP2006/003037

§ 371 Date: Sep. 19, 2007

(30) Foreign Application Priority Data
Apr. 7, 2005 (DE) 10 2005 016 039.5

(51) Int. Cl. B32B 3/26; B29C 67/20; B29C 35/02

(52) U.S. Cl. 428/304.4; 264/80

(57) ABSTRACT

The invention relates to a method for opening the film layer of a plastic foam strip, to a plastic foam strip that can be obtained by said method and has an at least partially opened film layer, and to the use thereof, for example, as a filtration membrane, an oil absorber, or a liquid-absorbent packaging material.

The present invention relates to a method of opening the film layer of plastic foam strip and also to plastic foam strip obtainable by this method, having an at least partly opened film layer, and to its use, for example, as a filtration membrane, oil absorber or liquid-absorbing packaging material.

Plastic foam strips are very well established and are put to diverse uses. They are generally produced by extruding a thermoplastic together with a blowing agent such as carbon dioxide, for example. At the exit from the extrusion die the blowing agent distributed finely in the plastic undergoes expansion to form ultrafine bubbles, thereby producing a plastic foam. In addition to this there are other methods known for producing plastic foam strip. The plastic foam strips thus produced are composed of generally closed, gas-filled cells, the gas enclosed in the cells generally constituting air and/or residues of the blowing agent. On account of these closed, gas-filled cells, plastic foam strips of this kind have excellent insulation properties and are therefore used, for example, as insulating materials in the construction sector or as packaging material.

In addition, however, there are also plastic foam strips known in which the cells are not closed but instead are at least partly opened and communicate with one another. Plastic foam strips of this kind can likewise be produced by conventional methods and are capable of absorbing liquids, like a sponge. Nevertheless, as a consequence of the typical production methods, plastic foam strips of this kind generally have a closed film layer on the surface (also referred to below as “surface film layer”). The at least partly opened and intercommunicating cells or pores lie hidden beneath this film layer. Consequently plastic foam strip of this kind or an article formed from it is able to absorb liquids only when the film layer is at least partly opened so as to expose the cells lying beneath the film layer. Plastic foam strip of this kind can be used, for example, as an oil absorber or as a liquid-absorbing packaging material for foods. Where both the top and the bottom faces of the plastic foam strip have been provided with at least partly opened film layers, and where the cells of the plastic foam strip are at least partly opened and in communication with one another, the plastic foam strip or an article produced from it can also be used as a microporous membrane.

There is therefore a desire to develop methods with which the surface film layer of plastic foam strip can be opened. A number of methods are known in the state of the art.

EP-A-0 718 077 describes a method of perforating surfaces of plastic foam strip, a needle tool being used to perforate the plastic foam strip. The perforation, however, opens only a small part of the film layer, relative to the total area of the film layer. Moreover, as the number of holes increases, the complexity of tool manufacture goes up massively.

EP-A-0 642 907 describes a shaped structure composed of a thermoplastic foam which has one closed surface and one other surface which is opened at least in one subregion. The opening of the surface film layer in this case is accomplished by machining, such as scraping, slitting or perforating, of the extruded plastic foam. The disadvantage of this method lies in the difficulty of reproducing defined surfaces and also in the formation of dust or fine particles during downstream processing.

EP-A-0 754 488 describes a method of producing a microporous membrane from a foamed thermoplastic resin, the breaking of the cell interfaces being achieved by subjecting the thermoplastic foam to plastic deformation by stretching or calendering. This is a multistage method which, among other stages, may also include a heat treatment. The disadvantage of this method, however, is the high cost and complexity occasioned by the multiplicity of operating stages.

EP-A-0 707 935 describes a method of producing microcellular foams in strip form from amorphous thermoplastics, and in one preferred embodiment a further foaming is achieved by reheating after the foam strip has solidified. It is not clear from EP-A-0 707 935, however, what effect the reheating has on the surface film.

It is an object of the present invention, accordingly, to provide a simple method which permits extensive opening of the film layer of plastic foam strip substantially without adverse effect on the structure of the cells or pores located beneath the film layer. A further intention is to provide plastic foam strip having an at least partly opened film layer.

This object is achieved by the embodiments characterized in the claims.

Provided in particular is a method of opening the film layer of plastic foam strip, in which the plastic foam strip is passed through a heater, the film layer of the plastic foam strip being at least partly opened by the short-term action of heat, caused by heating means disposed in the heater, on the surface of the strip.

The plastic foam strip can be constructed from one or more polymers or copolymers. Examples of such polymers and copolymers are polyolefins such as polyethylene, polypropylene, polypropylene copolymers, ethylene-vinyl acetate copolymers or chlorinated polyolefins, for example, and styrene polymers such as polystyrene, polystyrene copolymers, acrylonitrile-butadiene-styrene copolymers or styrene-maleic anhydride, for example. Further examples are polyesters such as polyethylene terephthalate or polybutylene terephthalate, polyvinyl chloride, polyphenylene oxide, polyamide, and polysulfone.

The plastic foam strip can be a single-layer strip or is the outer layer in a plastic strip or strip of multilayer construction.

Depending on the production method, the plastic foam strip carries one surface film layer or one top and one bottom surface film layer, this layer being substantially closed prior to the passing of the plastic foam strip through the heater. The thickness of the surface film layer can be in the range from about 0.1 to about 20 μm. The thickness of the surface film layer can be preferably in the range from about 1.0 to about 10 μm.

The plastic foam strip further has a cell or pore structure which is disposed beneath the top or bottom surface film layer or between the two surface film layers. This pore structure may be composed at least in part of opened, intercommunicating pores.

Passing the plastic foam strip through the heater can be accomplished in a conventional way. For example, the plastic foam strip can be guided on rolls or rollers through the heater.

The heater may comprise one or more heating means, the heating means being disposed in the heater preferably in such a way that their heat acts on the top and/or bottom face of the plastic foam strip. Where the plastic foam strip forms the outside layer in a plastic strip of multilayer construction, the heat of the heating means acts only on the side of the plastic strip that carries the plastic foam strip having a film layer. Where the plastic foam strip is a single-layer strip, the heat of the heating means may act from the top or bottom face or from the top and bottom faces, depending on the use of the plastic foam strip thus treated. On each side the heat may act on the plastic foam strip by one or more heating means.

One example of a heater suitable for the method of the invention is a singeing machine.

In one preferred embodiment of the present invention the heating means are the flame or flames of one or more gas burners. The gas burners can be operated, for example, using butane. The heating means are not restricted, though, to the flame or flames of one or more gas burners. It is possible, furthermore, for the burners to be operated with fuels other than gas, such as gasoline, petroleum or kerosine, for example. The temperature of the flame depends on the fuel that is used.

The temperature of the heating means is preferably selected such that the heat action of the heating means on the surface of the plastic foam strip opens the surface film of the plastic foam strip. This opening is accomplished by the melting and/or evaporation and/or combustion of the material of which the surface film is composed, as a result of the heat action. In one preferred embodiment of the method of the invention the temperature of the one or more heating means is in the range from about 700 to about 1800° C., preferably from about 1100 to 1200° C.

The distance of the heating means from the plastic foam strip can also be varied, in order to adjust the effective temperature at the surface of the plastic foam strip.

A possibility likewise is to vary the angle at which the heating means is disposed relative to the surface of the plastic foam strip. In one preferred embodiment the heating means are disposed at an angle of about 0 to about 90°, relative to the surface of the plastic foam strip. In one preferred embodiment of the method of the invention the rate of travel of the plastic foam strip through the heater is in the range from about 30 to about 150 m/min, preferably from about 60 to about 90 m/min, and more preferably from about 70 to about 80 m/min.

Surprisingly the short-term action of heat on the surface of the plastic foam strip has a film-opening effect, with the short-term heat action having no perceptible effect on the foam structure in the interior of the plastic foam strip. The film opening is probably brought about by melting and/or by the occurrence of what is called the memory effect. The phenomenon known as the memory effect is that whereby thermoplastics which in the course of processing pass through a particular fine structure exhibit a tendency to return to that condition later on. Through the method of the invention, a film layer present on the top and/or bottom face of the plastic foam strip can be at least partly opened. The extent of the opening can be determined, for example, by viewing a scanning electron micrograph of the surface film layer after passage of the plastic foam strip through the heater, after appropriate evaluation. In one preferred embodiment the method of the invention opens the film layer on the top and/or bottom face in each case to an extent of at least 30%, preferably in each case to an extent of at least 50%, and more preferably in each case to an extent of at least 70%, based on the respective total area of the film layer.

The present invention further provides a plastic foam strip having an at least partly opened film layer which is obtainable by the method of the invention.

The plastic foam strip may be constructed of one or more polymers or copolymers as defined above. Furthermore, the plastic foam strip of the invention carries one, or one top and one bottom, surface film layer or film layer, the film layer on the top and/or bottom face being opened in each case to an extent of at least 30%, preferably in each case to an extent of at least 50%, and more preferably in each case to an extent of at least 70%, based on the respective total area of the film layer. Furthermore, the plastic foam strip has a cell or pore structure as defined above.

The present invention further provides an article which can be produced from the plastic foam strip of the invention, more particularly for use as, for example, a filtration membrane (in the case, for example, of double-sided opening of the film layers), an oil absorber or a liquid-absorbing packaging material (in the case, for example, of single-sided opening of the film layers). A filtration membrane of the invention can be used, for example, as a filter, battery separating element, electrolyte condenser separating element, moisture-permeable watertight clothing or gas separation membrane. The packaging material of the invention can be utilized, for example, for meat products, fruit, vegetables or what is called fast food.

In the figures:

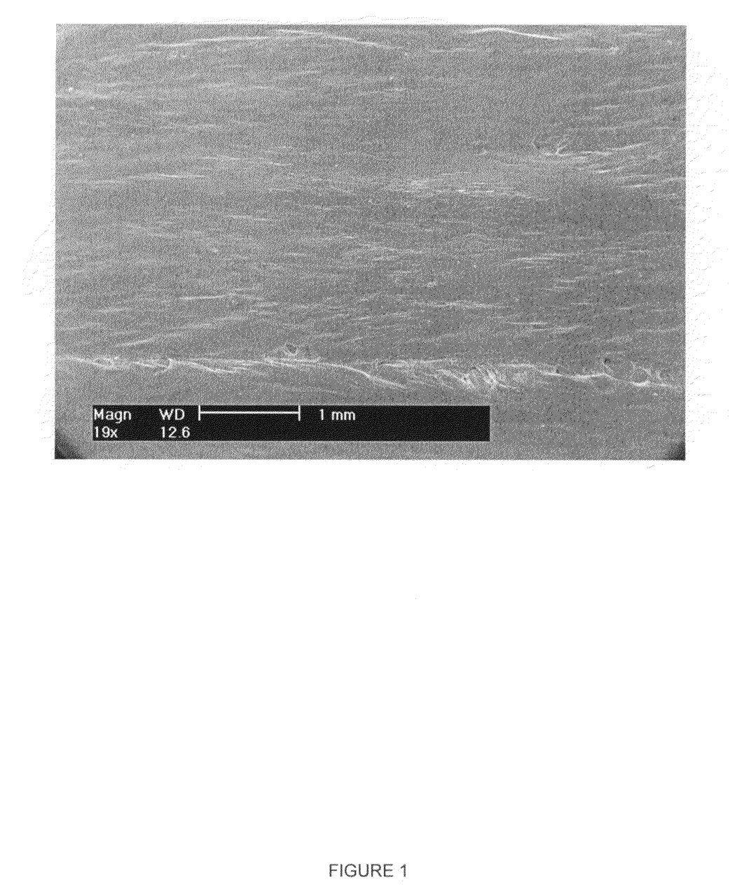

FIG. 1 shows the image of a scanning electron micrograph of the surface film of the plastic foam strip from example 1 prior to passage through a singeing machine.

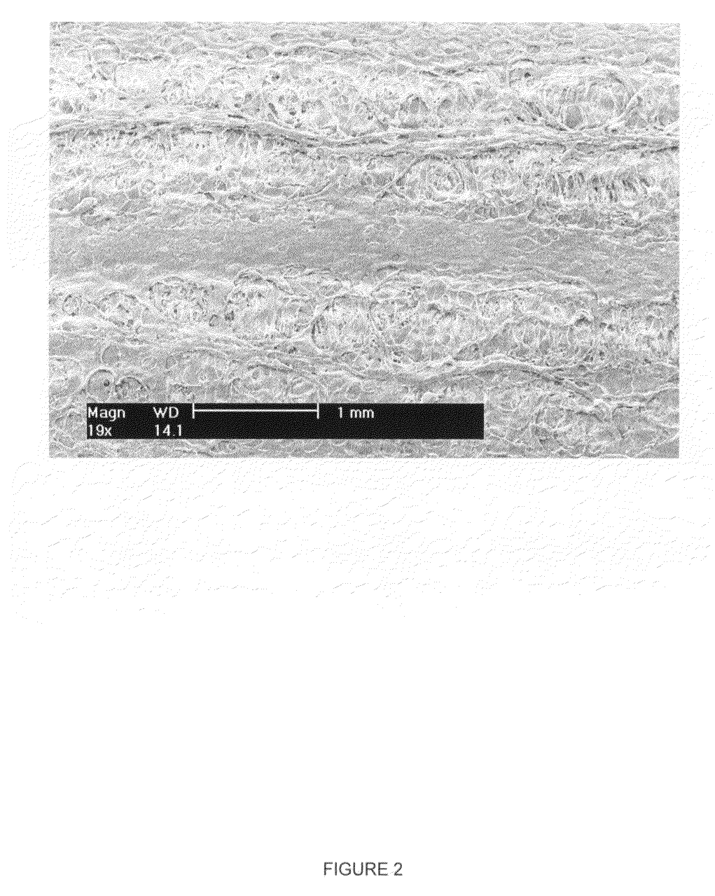

FIG. 2 shows the image of a scanning electron micrograph of the surface film of the plastic foam strip from example 2 after passage through a singeing machine.

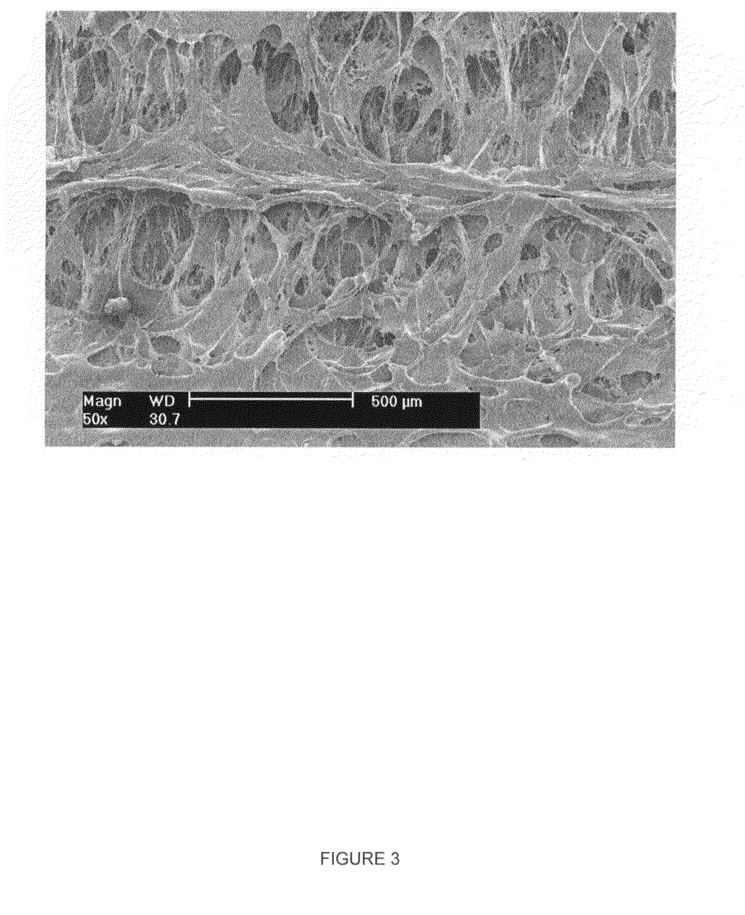

FIG. 3 shows the image of a scanning electron micrograph of the exposed pore structure of the plastic foam strip from example 2 after passage through a singeing machine.

The present invention is illustrated below with reference to examples.

### Example 1

### Production of a Plastic Foam Strip with Closed Surface Film

Polypropylene granules are extruded through a single-screw extruder heated at 220° C. with a throughput of 6 kg/h. CO₂ is passed into the melted polymer via a metering means under a pressure of 170 bar. The polymer/gas mixture is adjusted via a gear pump in such a way that there is an initial pressure of approximately 300 bar for a given melt temperature of about 175° C. Downstream of the mixer unit is a second gear pump for throughput regulation. The pressure after the second gear pump is 100 bar. Subsequently the gas-charged melt is conveyed into the extrusion tool and shaped at the exit through an annular die having a 35 mm exit diameter. The film bubble produced is drawn off over a cooling mandrel, slit at the foot of the cooling mandrel, collapsed, transported via the takeoff to the winder, and rolled up. The plastic foam strip thus obtained is composed essentially of polypropylene, has been foamed with 4.5% of CO₂ blowing agent, and has a thickness of 0.35 mm and an open cell count of more than 80%. The thickness of the closed surface film layer is about 2 μm.

### Example 2

### Production of a Plastic Foam Strip Having a Partly Opened Surface Film Layer on both Sides

A plastic foam strip produced as in example 1 is clamped in a singeing machine having two burners and is flamed on both sides at a rate of travel of 75 m/min. The gas used for the burners is an air/natural gas mixture in a ratio of 4 to 1. The singeing flame strikes the plastic foam strip, which runs via a water-cooled roller, at an angle of 90°.

Following passage through the singeing machine the thickness of the plastic foam strip is 0.3 mm. Scanning electron micrographs show that, after flaming, more than 50% of the film surface has been opened and that the underlying pore structure is exposed. FIG. 1 shows the scanning electron micrograph of the plastic foam strip prior to passage through the singeing machine. FIGS. 2 and 3 show scanning electron micrographs of the plastic foam strip after passage through the singeing machine.

### Example 3

### Water Transit Measurements with the Opened Plastic Foam Strip of Example 2

Using a double-sidedly opened plastic foam strip produced as in example 2, water transit measurements were carried out in accordance with DIN 58355 part 1. For these measurements a disk with a diameter of 50 mm was punched from the plastic foam strip, wetted with isopropanol and inserted into a filter holder. Water was then passed through the membrane under a constant pressure of 1 bar, and the time taken for 100 ml of water to pass through was recorded. In this way the specific transit rate L was determined for 20 samples taken from different points on the plastic foam strip, in accordance with the following equation:

L=V/(t·A·P)

where L represents the specific transit rate in ml·min⁻¹·cm⁻²·bar⁻¹, V indicates the volume in ml, t shows the filtration time in min, A is the effective filtration area in cm², and P is the transmembrane pressure in bar. This resulted in specific transit rates L of between 20 and 30 ml·min⁻¹·cm²·bar⁻¹.

1. A method of opening the film layer of a plastic foam strip, in which the plastic foam strip is passed through a heater, the film layer of the plastic foam strip being at least partly opened by the action of heat, caused by heating means disposed in the heater, on the surface of the strip.

2. The method of claim 1, wherein the plastic foam strip is a single-layer strip or is the outer layer in a strip of multilayer construction.

3. The method of claim 1, wherein the film layer is on the top and/or bottom face of the plastic foam strip.

4. The method of claim 1, wherein the heating means in the heater are disposed in such a way that their heat acts on the top and/or bottom face of the plastic foam strip.

5. The method of claim 1, wherein the temperature of the heating means is in the range from about 700 to about 1800° C.

6. The method of claim 1, wherein the heating means are disposed at an angle of about 0 to about 90°, relative to the surface of the plastic foam strip.

7. The method of claim 1, wherein the heating means are the flame or flames of one or more gas burners.

8. The method of claim 1, wherein the rate of travel of the plastic foam strip through the heater is in the range from about 30 to about 150 m/min.

9. The method of claim 1, wherein the film layer is opened on the top and/or bottom face in each case to an extent of at least 30%, relative to the respective total area of the film layer.

10. A plastic foam strip having an at least partly opened film layer, obtainable by the method of claim 1.

11. (canceled)
